(19) United States
(12) Patent Application Publication
(10) Pub. No.: US 2005/0050925 A1
(43) Pub. Date: Mar. 10, 2005

(54) Door for washing machne and method for manufacturing the same

(76) Inventors: Byoung Soo Je, Busan (KR); Soung Bong Choi, Chanwon-si Gyeongsangnam-do (KR); Jong Ho Kim, Chanwon-si Gyeongsangnam-do (KR)

Correspondence Address: MCKENNA LONG & ALDRIDGE LLP, 1900 K STREET, NW, WASHINGTON, DC, 20006, US

(21) Appl. No.: 10/474,693

(22) PCT Filed: Feb. 14, 2003
(86) PCT No.: PCT/KR03/00316

(30) Foreign Application Priority Data
Feb. 14, 2002 (KR) 2002/008044
Feb. 14, 2002 (KR) 2002/008042
Feb. 14, 2002 (KR) 2002/008045
Feb. 14, 2002 (KR) 2002/008046

(51) Int. Cl. B08B 3/12

(52) U.S. Cl. 68/3 R; 264/328.1

(57) ABSTRACT

Door 30 for a washing machine including a body 31 designed to open/close an opening 12a for introducing laundry into a tub 11a, a transparent part 31a formed at least a part of the body 31 for having a view of an inside of the tub 11a, and a first layer 33 of a hydrophilic material on an inside surface of the transparent part 31a.

### TECHNICAL FIELD

The present invention relates to washing machines, and more particularly, to a door for a washing machine.

### BACKGROUND ART

In general, the washing machine is provided with a tub provided therein for rotating and washing laundry introduced therein. For introduction of the laundry, or taking out the laundry, a housing of the washing machine is provided with a door. It is required for a user to open the door, in general formed of a non-transparent material, for confirmation of a state of the laundry during washing. However, in general, the washing machine is designed to stop operation of the washing machine if the door is opened, for the safety of the user. Therefore, unnecessary opening of the door may cause a prolonged total washing time period.

Under this reason, a partly transparent door has been developed, for having a view of an inside of the tub even during the washing. However, even with the partly transparent door, the user can not have the view of the inside of the tub due to the door clouded up with steam in a case hot washing water is used inside of the tub.

Moreover, the door, formed in general of a plastic, becomes to have scratches during use, which makes the user difficult to determine an inside state of the tub as the scratches increases.

### DISCLOSURE OF THE INVENTION

An object of the present invention designed to solve the foregoing problems is to provide a door for a washing machine which has a transparent part which has no clouded up with steam.

Another object of the present invention is to provide a door for a washing machine which has a transparent part which hardly forms scratches.

In one aspect of the present invention to achieve the objects, there is provided a door for a washing machine including a body designed to open/close an opening for introducing laundry into a tub, a transparent part formed at least a part of the body for having a view of an inside of the tub, and a first layer of a hydrophilic material on an inside surface of the transparent part.

Preferably, the body may be transparent, entirely. The body and the transparent part may be formed of ABS resin or PC resin.

The first layer may be a coated layer formed by coating a liquid hydrophilic material, or a film layer formed by attaching a film of a hydrophilic material. Preferably, the first layer is formed of cross-linked polyurethane.

The door may further include a second layer of a high hardness material on an outside of the transparent part.

The second layer may be a coated layer formed by coating a liquid high hardness material, or a film layer formed by attaching a film of a high hardness material. Preferably, the second layer is formed of cross-linked polyurethane.

In another aspect of the present invention, there is provided a method for fabricating a door for a washing machine, including the steps of forming a body of a door to include a transparent part at least partly, washing the transparent part, and forming a first layer of a hydrophilic material on an inside surface of the transparent part.

The step of forming includes the step of injection molding of the body and the transparent part.

The step of washing may include the step of washing the transparent part with a wash liquid, and the transparent part is dried for a predetermined time period after the step of washing. The step of washing may include the step of blowing compressed air to the transparent part.

The step of forming a first layer may include the step of coating a liquid hydrophilic material on the transparent part, and the step of coating may include the step of spraying the hydrophilic material onto the transparent part, or the step of dipping the transparent part into the hydrophilic material. The transparent part is dried after the step of coating, preferably in a room at a room temperature for at least 24 hours.

The step of forming a first layer may include the step of attaching a film of hydrophilic material to the transparent part.

The method for fabricating a door of the present invention may further include the step of forming a second layer of a high hardness material on an outside of the transparent part after the step of washing.

The step of forming a second layer may include the step of coating a liquid high hardness material on the transparent part, or attaching a film of the high hardness material to the transparent part.

Preferably, the first or second layer is formed of cross-linked polyurethane.

In further aspect of the present invention, there is provided a washing machine including a housing, a tub mounted in the housing rotatable by predetermined power means for washing laundry, and a door including a body for opening/closing an opening in the housing so as to be in communication with the tub, a transparent part formed at least a part of the body for having a view of an inside of the tub, and a first layer of a hydrophilic material on an inside surface of the transparent part.

Preferably, the door further includes a second layer of a high hardness material on an outside of the transparent part.

In still further aspect of the present invention, there is provided a door for a washing machine fabricated by the steps of forming a body of a door to include a transparent part, at least partly, washing the transparent part, and forming a first layer of a hydrophilic material on an inside surface of the transparent part, and forming a second layer of a high hardness material on an outside surface of the transparent part.

### BRIEF DESCRIPTION OF DRAWINGS

The accompanying drawings, which are included to provide a further understanding of the invention, illustrate embodiments of the invention and together with the description serve to explain the principles of the invention:

In the drawings:

FIG. 1 illustrates a perspective view showing a washing machine having a door of the present invention provided thereto;

FIG. 2 illustrates a partial perspective view showing a washing machine door of the present invention;

FIGS. 3A and 3B illustrate partial sections each showing a door of the present invention; and

FIG. 4 illustrates a flow chart showing the steps of a method for fabricating a washing machine door in accordance with a preferred embodiment of the present invention.

### BEST MODE FOR CARRYING OUT THE INVENTION

Preferred embodiments of the present invention which can achieve the objects of the present invention will be described with reference to the attached drawings. In describing the embodiments, same parts will be given the same names and reference symbols, and repetitive description of which will be omitted.

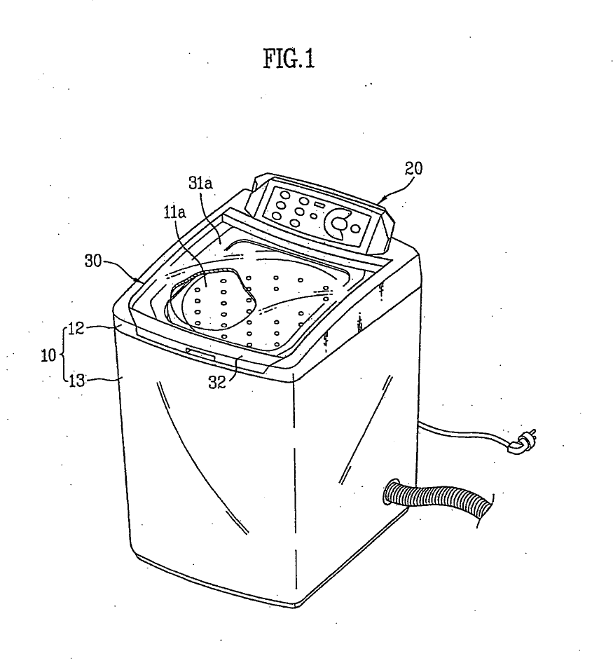

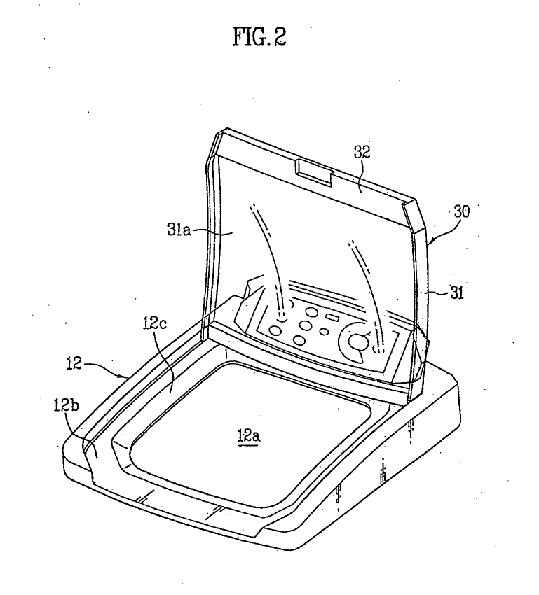

FIG. 1 illustrates a perspective view showing a washing machine having a door of the present invention provided thereto, and FIG. 2 illustrates a partial perspective view showing a washing machine door of the present invention. Referring to the drawings, the washing machine and a door for a washing machine will be described.

The washing machine of the present invention includes a housing 10, and various components inside of the housing for washing on a large scale. The housing 10 includes a cabinet 11 in a lower part and a top cover 12 over the cabinet 11, on the whole.

The cabinet 11 in the lower part is designed to mount major components of the washing machine thereon, and protects the components. There are a tub 11a and driving means (not shown) for rotating the tub 11a provided to an inside of the cabinet 11. The tub 11a holds the laundry and rotatably fitted to an inside of the cabinet 11. The driving means, mounted adjacent to the tub 11a, provides a power for rotating the drum 11a. In general, the driving means includes a motor, a driving shaft and a clutch or a belt for coupling the motor and the driving shaft, and the driving shaft is connected to the tub 11a. Therefore, the tub 11a washes, and extracts water from, the laundry therein as the tub 11a is rotated by the driving means.

The top cover 12 covers a top of the cabinet, to protect the components, too. As shown in FIG. 2, the top cover 12 has an opening 12a for introducing or taking out laundry. The top cover has a seat part 12b for seating a door 20 to be described later. A skirt part 12c is extended to a length from a boundary of the seat part 12b and the opening 12a, for guiding the laundry introduced through the opening 12a.

The top cover 12 has an operational part 20 and a door 30. The operational part 20 is positioned in a rear part of the top cover 12, in a front face of which, there is a control panel for operation of the washing machine. There is a controller (not shown) provided to an inside of the operational part 20 operably connected to the control panel for controlling operation of the washing machine. As shown in FIGS. 1 and 2, the door 30 is designed to open or close the opening 12a in communication with the tub 11a. In more detail, the door 30 is hinged to the top cover 12, to be rotatable around the hinge in opening or closing the opening 12a. That is, the laundry is introduced into the tub 11a after opening the door 30, and the washing and water extraction are made as the tub 11a is rotated after the door 30 is closed. In the meantime, as described before, though the door 30 and the opening 12a are provided to the top cover 12, the door 30 and the opening 12a may be provided to the cabinet 11 depending on an arrangement of the tub 11a.

The door 30 will be described in more detail.

Referring to FIG. 2, the door 30 includes a body 31 and a handle 32, on a large scale. In the door 30, the body 31 serves to open or close the opening 12a as the body 31 is rotated. Therefore, according to the embodiment of the present invention shown in the drawing, though the body 31 is a rectangle larger than the opening 12a, the body 31 may have any form as far as the form can open/close the opening 12a. The body 31 has a transparent part 31a at least partly. The user can determine a state of the laundry inside of the tub adjacent to the door 30 through the transparent part 31a any time the user desires. Preferably, as shown in FIG. 2, for the user to have a view of the inside of the tub 12a with easy, the transparent part 31a may be formed throughout the body 31. That is, the entire body 31 may be transparent. Through such a transparent body 31, the user can have a view of, not only the tub 12a, but also other adjacent parts, which permits the user to determine abnormal operation of the washing machine, too. The body 31 is formed of a plastic, and particularly, the transparent part 31a is formed of a transparent plastic, such as ABS (Acrylonitrile Butadiene Styrene) resin and PC (Polycarbonate). The handle 32 is a part to be gripped by the user when the door 30 is opened/closed. The handle 32 may be formed separate from the body 31 and fixed to the body 31, or as a unit with the body 31. The handle 32 may be formed of the plastic the same with the body 31.

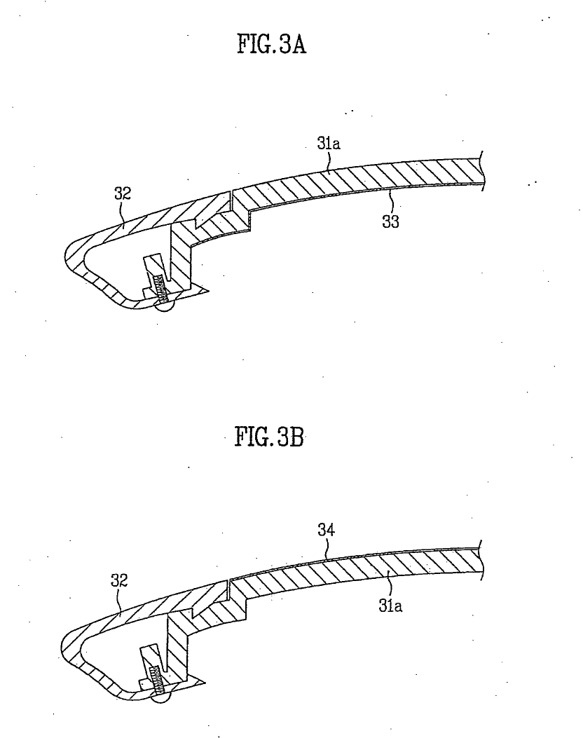

In the meantime, warm or hot washing water is used depending on kinds and states of laundry during operation of the washing machine. Owing to such washing water, a surface of the body 31 inclusive of the transparent part 31a is clouded up with steam or has water drops formed thereon. Particularly, an inside surface of the transparent part 31a facing the tub 11a may be clouded up with steam as the warm or hot washing water is introduced into the tub 11a, such that the user can not determine a state of the laundry in the tub 31a. As shown in FIG. 3A, owing to the reason, the transparent part 31a has a first layer 33 of a hydrophilic material formed on an inside surface thereof.

The hydrophilic material absorbs a portion of water vapor the hot water generates. Also, the hydrophilic material makes condensed water vapor to spread on a surface of the material, preventing formation of water drops. Accordingly, the first layer 33 prevents the inside surface of the transparent part 31a from being clouded up with steam or having water drops formed thereon. Though there are a variety of hydrophilic materials, cross-linked polyurethane is the most preferable. In the present invention, the cross-linked polyurethane is formed to be two-part hydrophilic.

The first layer 33 may be formed by coating a liquid hydrophilic material on the inside surface of the transparent part 31a. Or, the hydrophilic material may be formed in a form of a film, and attached to the inside surface of the transparent part 31a to form the first layer 33.

Since an outside of the transparent part 31a is exposed to an exterior and formed of a plastic, the outside surface is susceptible to have scratches formed therein. As the scratches increase, the transparent part 31a loses its own transparency, such that the user can hardly have an inside view of the tub 11a. Owing to the reason, as shown in FIG. 3B, the door 30 preferably further includes a second layer 34 formed of a material of a high hardness on the outside surface of the transparent part 31a. A variety of high hardness materials may be applicable to the second layer 34. However, since the cross-linked polyurethane has, not only hydrophilicity, but also high hardness, it is preferable that the second layer 34 is formed of the cross-linked polyurethane. If the first and second layers 33 and 34 are formed of the same material (i.e., the cross-linked polyurethane), a fabrication process of the door 30 can be made to be once-through and simple, to reduce a production cost. The hydrophilicity of the second layer 34 prevents the outside surface of the transparent part 31a from formation of water drops or being clouded up with steam due to a temperature difference between the outside surface and the inside surface of the transparent part 31a. On the other hand, as described before, since the cross-linked polyurethane has a high hardness, the first layer 33 of the cross-linked polyurethane prevents, not only the clouded up with steam, but also the scratches.

Similar to the first layer 33, the second layer 34 may be formed by coating a high hardness material on the outside surface of the transparent part 31a, or attaching a high hardness material film on the outside surface.

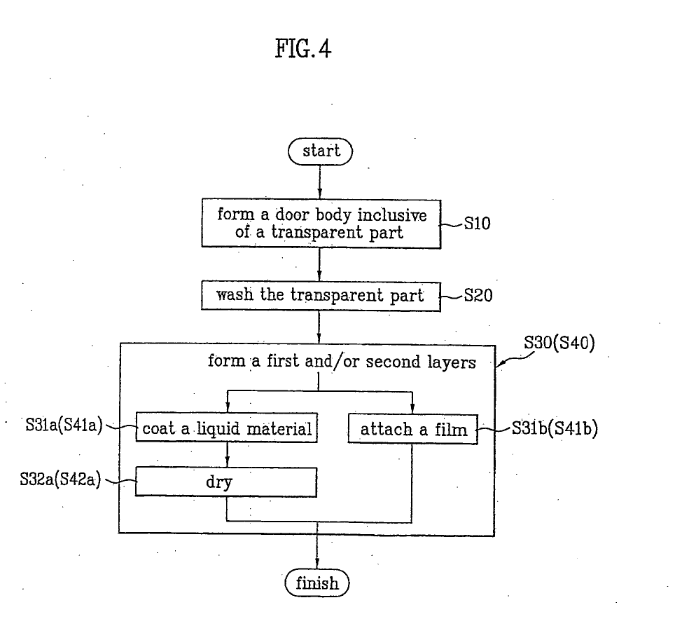

A method for manufacturing a door of the present invention will be described with reference to FIG. 4, and characteristics of the door of the present invention will be described in more detail.

The body 31 of the door 30 is formed to include a transparent part 31a, at least partly (S10). As described before, the door body 31 is formed of ABC or PC resin by injection molding. By injecting molding the transparent resin and the non-transparent resin at the same time, the transparent part 31a can be formed as a part of the body 31. Preferably, the body 31 may be formed of transparent material, fully.

When the forming step (S10) is finished, the body 31, more precisely, the transparent part 31a is washed (S20). In the washing step (S20), the transparent part 31a may be washed with, for an example, a wash liquid. Moreover, for removing impurities, high pressure air may be blown to the transparent part 31a. When the wash liquid is used, a process for drying the transparent part 31a for a preset time period after the washing is required. However, when the air is used, no extra drying process is required. On the other hand, the transparent part 31a may be dried with the high pressure air after the wash with the wash liquid.

Then, a first layer 33 is formed on an inside surface of the transparent part 31a (S30). As described before, the first layer 33 is formed of a hydrophilic material, preferably cross-linked polyurethane, for prevention of an inside surface from being clouded up with steam.

In the forming step (S30), the first layer 33 may be formed by coating a liquid hydrophilic material on the transparent part 31a (S31a). In more detail, for forming the first layer 33, the liquid hydrophilic material may be sprayed onto the transparent part 31a. Or, the transparent part 31a may be dipped into the liquid hydrophilic material, so that the hydrophilic material stuck to the transparent part 31a during the dipping forms the first layer 33. For reference, the liquid hydrophilic material is prepared by dissolving a hydrophilic material in a proper solvent. For an example, the solvent may be prepared by mixing a first solvent consisting of diacetone alcohol, cyclohexane, tertiary butanol, and N-methyl pyrrolidone, and a second solvent consisting of N-butylacetate/xylene. The first solvent has 27% of solid and a viscosity of 8-25 cps, and the second solvent has 73% of solid, and a viscosity of 200-500 cps. The first and second solvents are mixed at a volumetric ratio of 2.8:1, and agitated to mix uniformly before addition of the hydrophilic material.

After the liquid material coating step (S31a), for setting the first layer 33, it is required to dry the transparent part 31a for a preset time period (S32a). In this instance, for stable formation of the first layer 33, it is preferable that the transparent part 31a is dried in a room at a room temperature, naturally. A time period of the dry is required to be longer than 24 hours.

Or, the first layer 33 may be formed by attaching a film of the hydrophilic material to an inside surface of the transparent part 31a (S31b). The film is formed of a hydrophilic material, preferably cross-linked polyurethane in advance, and cut to be identical to an inside surface size of the transparent part 31a. The cut film are attached to the inside surface of the transparent part 31a with an adhesive. The use of ready-made film dispenses with an extra drying process after the attaching step (S31b).

In the meantime, after the washing step (S20), in addition to the first layer 33, a second layer 34 may be formed on an outside surface of the transparent part 31a (S40). The second layer 34 is formed of a high hardness material, for prevention of formation of scratch, preferably cross-linked polyurethane identical to the first layer 33. In the forming step (S40), the second layer 34 may be formed by coating the liquid high hardness material on the outside surface of the transparent part 31a (S41a), or attaching a film of the high hardness material to the outside surface of the transparent part 31a. In the coating step (S41a), the liquid high hardness material may be sprayed onto the outside of the transparent part 31a, or the outside of the transparent part 31a may be dipped into the liquid hydrophilic material. After the coating step (S41a), the transparent part 31a is naturally dried in a room at a room temperature for at least 24 hours for setting the second layer 34 (S42a). Since such a series of second layer forming steps (S41a, S42a, and S41b) are actually identical to the prior first layer forming steps (S31a, S32a, and S31b), repetitive detailed description will be omitted. Owing to the identical steps, the second layer forming step (S40) can be carried out at the same time with the first layer forming step (S30), thereby simplifying a fabrication process and reducing unit cost. That is, it is preferable that the first and second layers 33 and 34 are formed at the same time. Moreover, as described before, when the first and second layers 33 and 34 are formed of the same material, i.e., the cross-linked polyurethane, an efficiency of a fabrication process can be enhanced further.

After finishing the first forming step (S30) and/or the second forming step (S40), a handle 32 is formed as a unit with the door body 31 or attached to the door body 31. The door 30 finished to open/close the opening 12a is rotatably fitted to the washing machine.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### Industrial Applicability

The door of the present invention includes a transparent part and a hydrophilic first layer on the transparent part, and prevents an inside of the transparent part form being clouded up with steam or formation of water drops. Accordingly, even during a warm water washing, the user can have a clear view of an inside of the tub, which is convenient to the user, actually.

Moreover, the additional second layer of high hardness on an outside surface of the transparent part of the door prevents scratches formed in the transparent part. Thus, the second layer can maintain a good view of the inside of the tub.

1. A door for a washing machine comprising:
a body designed to open/close an opening for introducing laundry into a tub;
a transparent part formed at least a part of the body for having a view of an inside of the tub; and
a first layer of a hydrophilic material on an inside surface of the transparent part.

2. The door as claimed in claim 1, wherein the body is transparent, entirely.

3. The door as claimed in claim 1, wherein the body and the transparent part are formed of ABS resin or PC resin.

4. The door as claimed in claim 1, wherein the first layer is a coated layer formed by coating a liquid hydrophilic material.

5. The door as claimed in claim 1, wherein the first layer is a film layer formed by attaching a film of a hydrophilic material.

6. The door as claimed in claim 1, wherein the first layer is formed of cross-linked polyurethane.

7. The door as claimed in claim 1, further comprising a second layer of a high hardness material on an outside of the transparent part.

8. The door as claimed in claim 7, wherein the second layer is a coated layer formed by coating a liquid high hardness material.

9. The door as claimed in claim 7, wherein the second layer is a film layer formed by attaching a film of a high hardness material.

10. The door as claimed in claim 7, wherein the second layer is formed of cross-linked polyurethane.

11. A method for fabricating a door for a washing machine, comprising the steps of:
forming a body of a door to include a transparent part, at least partly;
washing the transparent part; and
forming a first layer of a hydrophilic material on an inside surface of the transparent part.

12. The method as claimed in claim 11, wherein the body and the transparent part are formed by injection molding of a plastic.

13. The method as claimed in claim 12, wherein the body and the transparent part are formed of ABS resin or PC resin.

14. The method as claimed in claim 11, wherein the step of washing includes the step of washing the transparent part with a wash liquid.

15. The method as claimed in claim 14, further comprising the step of drying the transparent part for a predetermined time period after the step of washing.

16. The method as claimed in claim 11, wherein the step of washing includes the step of blowing compressed air to the transparent part.

17. The method as claimed in claim 11, wherein the step of forming a first layer includes the step of coating a liquid hydrophilic material on the transparent part.

18. The method as claimed in claim 17, wherein the step of coating includes;
the step of spraying the hydrophilic material onto the transparent part, or
the step of dipping the transparent part into the hydrophilic material.

19. The method as claimed in claim 17, further comprising the step of drying the transparent part after the step of coating.

20. The method as claimed in claim 19, wherein the transparent part is dried in a room at a room temperature for at least 24 hours.

21. The method as claimed in claim 11, wherein the step of forming a first layer includes the step of attaching a film of hydrophilic material to the transparent part.

22. The method as claimed in claim 11, wherein the first layer is formed of cross-linked polyurethane.

23. The method as claimed in claim 11, further comprising the step of forming a second layer of a high hardness material on an outside of the transparent part after the step of washing.

24. The method as claimed in claim 23, wherein the step of forming a second layer includes the step of coating a liquid high hardness material on the transparent part.

25. The method as claimed in claim 24, further comprising the step of drying the transparent part after the step of coating.

26. The method as claimed in claim 23, wherein the step of forming a second layer includes the step of attaching a film of a high hardness material to the transparent part.

27. The method as claimed in claim 23, wherein the second layer is formed of cross-linked polyurethane.

28. A washing machine comprising;
a housing;
a tub mounted in the housing rotatable by predetermined power means for washing laundry; and
a door including a body for opening/closing an opening in the housing so as to be in communication with the tub, a transparent part formed at least a part of the body for having a view of an inside of the tub, and a first layer of a hydrophilic material on an inside surface of the transparent part.

29. The method as claimed in claim 28, wherein the first layer is a coated layer formed by coating a liquid hydrophilic material.

30. The method as claimed in claim 28, wherein the first layer is a film layer formed by attaching a film of a hydrophilic material.

31. The method as claimed in claim 28, further comprising a second layer of a high hardness material on an outside of the transparent part.

32. The door as claimed in claim 31, wherein the second layer is a coated layer formed by coating a liquid high hardness material.

33. The door as claimed in claim 31, wherein the second layer is a film layer formed by attaching a film of a high hardness material.

34. The door as claimed in claim 28, wherein the first or second layer is formed of cross-linked polyurethane.

35. A door for a washing machine fabricated by the steps of:
forming a body of a door to include a transparent part, at least partly;
washing the transparent part; and
forming a first layer of a hydrophilic material on an inside surface of the transparent part, and forming a second layer of a high hardness material on an outside surface of the transparent part.

36. The door as claimed in claim 35, wherein the step of forming a first layer and a second layer includes the step of coating a liquid hydrophilic material and a high hardness material to an inside and an outside of the transparent part respectively, or the step of attaching a film of a hydrophilic material and a film of a high hardness material to the inside and the outside of the transparent part respectively.

37. The door as claimed in claim 36, wherein the hydrophilic material and the high hardness material are cross-linked polyurethane.
